(19) United States
(12) Patent Application Publication
(10) Pub. No.: US 2006/0176026 A1
(43) Pub. Date: Aug. 10, 2006

(54) Method for charging and maintaining a battery

(75) Inventors: Yi-Hung Shen, Taipei (TW); Chun-De Lin, Taipei (TW)

Correspondence Address: LOWE HAUPTMAN BERNER, LLP, 1700 DIAGONAL ROAD, SUITE 300, ALEXANDRIA, VA, 22314, US

(73) Assignee: COMPAL ELECTRONICS, INC., Taipei (TW)

(21) Appl. No.: 11/182,007

(22) Filed: Jul. 15, 2005

(30) Foreign Application Priority Data
Feb. 5, 2005 (TW) 094104044

(51) Int. Cl. H02J 7/00

(52) U.S. Cl. 320/135

(57) ABSTRACT

A method for charging and maintaining a rechargeable battery is provided. A time basis and a charging level are predetermined in the method. When the unused period of the battery does not exceeds the time basis, if the electric potential of the battery is more than the charging level, the battery will not be charged; otherwise, the battery will be charged. When the unused period of the battery exceeds the time basis, if the electric potential of the battery is more than the charging level, the battery will be discharged at first and then charged; otherwise, the battery will be directly charged.

### RELATED APPLICATIONS

The present application is based on, and claims priority from, Taiwan Application Serial Number 94104044, filed Feb. 5, 2005, the disclosure of which is hereby incorporated by reference herein in its entirety.

### BACKGROUND

1. Field of Invention

The present invention relates to a method for charging and maintaining a rechargeable battery. More particularly, the present invention relates to a charging and maintaining process used to improve the power efficiency and average service life of a rechargeable battery.

2. Description of Related Art

The development and progress of manufacturing techniques of electronic and information products has fueled the trend of integrating and miniaturizing various electronic apparatuses. Hence, many kinds of large-scale electronic apparatus, which were traditionally hard to carry, have gradually become portable, such as the laptop with regard to the desktop personal computer and the mobile phone with regard to the household telephone. The only power supply for these portable electronic apparatuses is a battery; thus, improving the battery has gradually become ever more important.

There are many kinds of battery can be used in a portable electronic apparatus, but the rechargeable batteries, such as the Ni-MH battery, Ni—Cd battery and Li-Ion battery, are preferred with regard for environmental protection. In general, all rechargeable batteries have problems of self-discharge, restriction on the number of times they can be recharged and discharged, and over-charging and over-discharging; and some kinds of the rechargeable batteries, such as Ni-MH and Ni—Cd batteries, further have the problem of memory effect.

Some characteristics of a rechargeable battery are described herein. The service life of a rechargeable battery is gradually reduced after every charging and discharging process, and the battery may be further damaged by over-charging and over-discharging. The electric energy stored in a battery gradually leaks over time even if the battery is not in use. The power storing capacity will be reduced when a battery is recharged at a higher storing level. These characteristics easily render a battery inappropriately charged or discharged, reducing the service life of the battery, damaging the battery and degrading the power efficiency of the battery.

Therefore, a method is provided in a Taiwan patent, which the issued number is 216248, for charging and discharging a Ni-MH or a Ni—Cd battery. This method discharges all the electric potential in the battery before charges the battery for preventing the memory effect in the battery. Thus, the battery is certainly discharged at first, regardless how much electric potential stored in the battery, and a large number of the electric energy and the operation efficiency of the battery may be wasted and degraded.

Generally, a charging level and/or a discharging level are preset in the battery to prevent the problems caused by over-charging and over-discharging. Thus, a charger will not further charge a battery when the electric potential in the battery is more than the charging level; similarly, the charger will not further discharge a battery when the electric potential in the battery is less than the discharging level. Although the charging level and the discharging level can be used to prevent the problems caused by over-charging and over-discharging in the conventional method, the method cannot prevent the inefficient use of the battery.

According to the foregoing description, the conventional method can only overcome some of the problems associated with a rechargeable battery. Therefore, a new method is needed to improve the service life, efficiency and convenience of a rechargeable battery since the rechargeable battery is a common power supply for portable electronic apparatuses nowadays.

### SUMMARY

It is therefore an objective of the present invention to provide a method for charging and maintaining a rechargeable battery.

It is another objective of the present invention to provide a charging and maintaining method to improve the service life of a rechargeable battery.

It is still another objective of the present invention to provide a charging and maintaining method to improve the power efficiency of a rechargeable battery.

It is another objective of the present invention to provide a charging and maintaining method to prevent the memory effect of a rechargeable battery.

According to the foregoing objectives of the present invention, whether the electric potential stored in the battery is more than a charging level is determined at first when a charging process is started, and then whether the battery is connected with a power supply is determined. If the electric potential stored in the battery is less than the charging level and the battery is connected with a power supply, the battery can be charged.

In the aspect of regular maintenance of the battery, whether the unused period of the battery exceeds a time basis is determined at first, and then whether the electric potential is less than a low quantity level is determined. If the unused period of the battery exceeds the time basis but the electric potential of the battery is not less than the low quantity level, the battery will be discharged and then charged; if the unused period of the battery does not exceeds the time basis and the electric potential of the battery is less than the low quantity level, the battery will be directly charged.

The power efficiency of a battery can be improved and the memory effect can be prevented by integrating and using the above-mentioned process.

### BRIEF DESCRIPTION OF THE DRAWINGS

These and other features, aspects and advantages of the present invention will become better understood with regard to the following description, appended claims and accompanying drawings where:

FIG. 1 is a diagram of the charging and discharging curve of a rechargeable battery;

FIG. 2 is a flow chart of a charging process according to an embodiment of the present invention; and

FIG. 3 is a flow chart of a charging and maintaining process according to an embodiment of the present invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

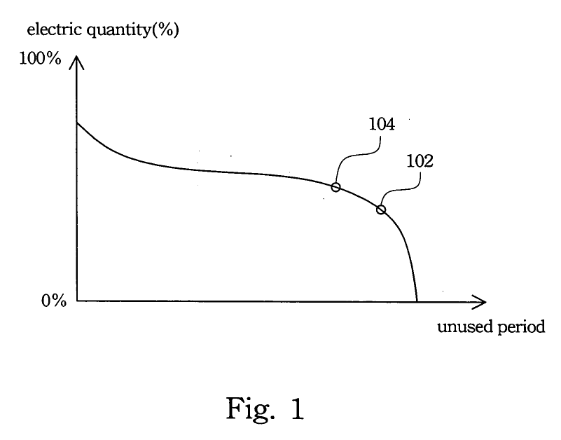

FIG. 1 shows the charging and discharging profile of the rechargeable battery in a portable electronic apparatus, wherein the vertical axis indicates the electric potential of a battery and the horizontal axis indicates the unused period of a battery. It can be seen that the electric potential gradually decreases with increasing unused period until the electric energy stored in the battery is exhausted. The electric energy stored in the battery cannot be further reduced and the battery generally cannot be used when the electric potential decreases below a low quantity level 102.

The basic concept of the present invention is to use the low quantity level to determine an operation region of the battery (i.e. the region before the low quantity level 102) and define another charging level 104 near and preceding the low quantity level 102 to determine whether the battery can be charged. Thus, the electric energy stored in the battery can be effectively used because the battery has high electric charging and the memory effect in the battery can be avoided. Furthermore, the battery can be maintained by way of discharging it and then charging it when the unused period of the battery exceeds a predetermined time basis; thus, the service life of the battery can be extended.

When a battery in an electronic apparatus, such as a laptop, is charged by a method according to the embodiment of the present invention, a life extending mode is enabled. Then, whether the electric potential of the battery is less than or equal to a predetermined charging level is determined; if so and the battery is connected with a power supply, the battery is charged; if not or if the battery is not connected with a power supply, the battery is stopped from charging to prevent the battery from charging while already having a high electric potential which would produce the memory effect in the battery.

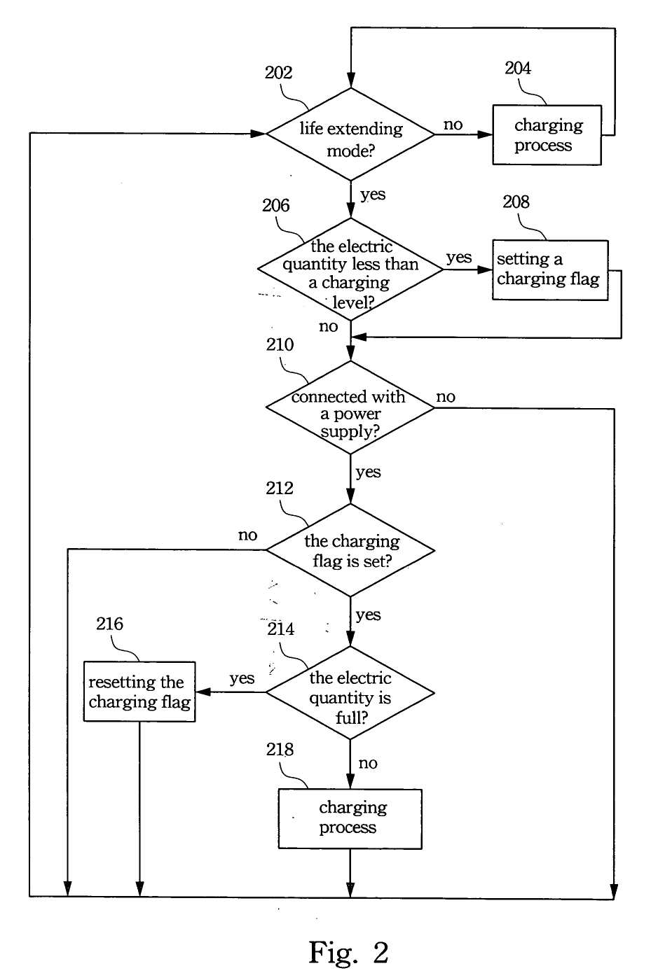

FIG. 2 shows a flow chart of the method according to an embodiment of the present invention. In the step 202, whether the battery life extending mode is enabled is determined by a user; if it is not set, the flow path enters the step 204 to carry out a general charging process. After the life extending mode is enabled, the electric potential of the battery is detected for determining whether the electric potential is less than a predetermined charging level in the step 206. If it is less, the flow path enters the step 208 to setting a charging flag for indicating that the battery needs to be charged; if not, the charging flag is not set. In the step 210, whether the battery is connected with a power supply used to charge the battery is determined. If it is not connected, the flow path returns to the beginning of the method, that is, the step 202; if it is connected, the flow path enters the step 212. In the step 212, whether the charging flag is set will be determined. If the flag is not set, the battery does not need to be charged and the flow path returns to the step 202; if it is set, the flow path is continued. In the step 214, the electric potential of the battery is detected again, and if the electric potential is full, the battery does not need to be charged, the charging flag is disabled and the flow path returns to the step 202; if the electric potential is not full, the flow path enters the step 218 to charge the battery and then returns to the step 202.

A battery maintaining process may be integrated into the foregoing battery charging process to become a charging and maintaining method. Whether the unused period of the battery exceeds or equals a predetermined time basis and whether the electric potential of the battery is less than or equal to the low quantity level of the battery are determined at first in the maintaining process. If the unused period exceeds or equals the time basis and the electric potential is not less than the low quantity level, the battery is discharged and then charged; otherwise, the battery is directly charged.

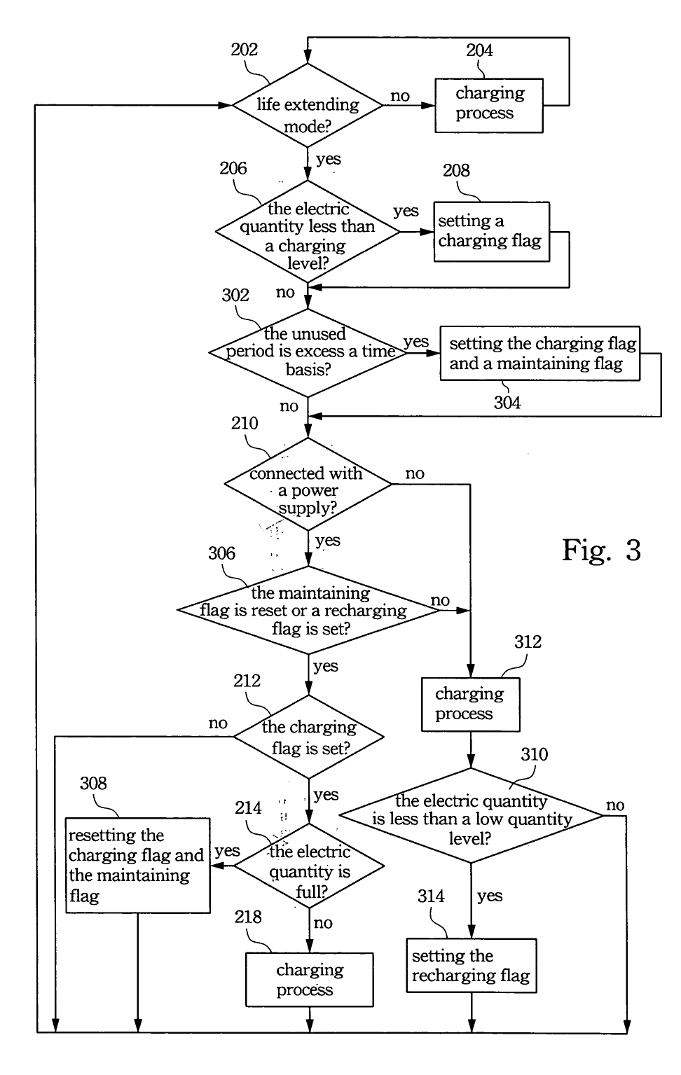

FIG. 3 shows a flow chart of a charging and maintaining method according to the above-mentioned description, wherein some of the steps in the flow chart shown in FIG. 3 are identical to the steps in the flow chart shown in FIG. 2; that is, steps 202-214 and step 218 shown in FIG. 3 are identical to the steps 202-214 and step 218 shown in FIG. 2. In addition, the step 308 is obtained by altering the step 216 shown in FIG. 2, and steps 302-306 and steps 310-314 are new steps.

In the step 302, whether the unused period of the battery exceeds or equals a predetermined time basis is determined. If it does, the flow path enters the step 304 to set a charging flag and a maintaining flag, wherein the maintaining flag is used to indicate that the battery needs a regular maintenance; if it does not exceed or equal the time basis, the flow path enters the step 210.

In the step 210, whether the battery is connected with a power supply will be determined. If it is connected, the flow path enters the step 306; if it is not connected, the flow path enters the step 312. In the step 306, whether the maintaining flag is not set or whether a recharging flag is set will be determined, wherein, the recharging flag is used to indicate the battery has been discharged and needs to be charged. Therefore, if the result of the step 306 is “no”, the electric potential of the battery is not less than the low quantity level yet and needs to be discharged further, and the flow path enters the step 312 to discharge the battery. After the battery is discharged in the step 312, whether the electric quantity of the battery is less than or equal to the low quantity level of the battery will be determined in the step 310. If so, the flow path enters the step 314; otherwise, the flow path returns to the step 202. In the step 314, the recharging flag is set and then the flow path returns to the step 202. The battery is charged in the next flow described as follows due to the electric potential is low and the recharging flag has been set.

If the result of the step 306 is “yes”, the battery needs to be charged or recharged, and the path flow enters the charging process comprising steps 212, 214, 218 and 308, which are identical to the charging process comprising the steps 212-218 shown in FIG. 2, except that the step 308 has one more motion than the step 216 of resetting the maintaining flag.

In the method shown in FIG. 3, whether the battery can be charged or maintained is determined by predetermining the charging level for keeping the best condition of the battery, but this may inconvenience the user in practice, such as when the battery needs to be urgently charged but cannot be charged because the electric potential is still more than the charging level. Therefore, some additional steps may be integrated into the method for improving flexibility. For example, a time scheduling step may be added between the step 202 and the step 206. The time scheduling step is able to prearrange the step 206 to start at some times to carry out the charging and maintaining process according to the embodiment of the present invention and the step 204 to start at some other times to carry out the conventional charging and discharging process. The time scheduling step may be implemented by a program, such as Microsoft Outlook, on an electronic apparatus, such as laptop. For example, the calendar function of Outlook may be used to prearrange that the battery is charged by the conventional charging process two hours before a conference or maintained by the process of the embodiment of the present invention on holidays. In addition, the time scheduling step may be also added before the step 302 to prearrange a maintenance time of the battery, or the step 304 may be coercively started by the user such as by a hot key to maintain the battery.

The characteristics of the present invention are that the charging level, the unused period, the connection of a power supply and the electric potential of a battery are considered to determine whether the battery should be charged or discharged; thus, the electric energy stored in the battery can be effectively used, the memory effect in the battery can be reduced and the service life of the battery can be further extended.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for charging and maintaining a rechargeable battery, comprising:
(a) enabling a life extending mode;
(b) determining whether the electric potential of said battery is less than or equal to a predetermined charging level;
(c) determining whether said battery is connected with a power supply; and
(d) charging said battery.

2. The method of claim 1, wherein said battery is used in a laptop.

3. The method of claim 1, wherein said battery is a Ni-MH battery or a Ni—Cd battery.

4. The method of claim 1, further comprising a step of determining whether a predetermined time is reached before said step (a).

5. The method of claim 4, wherein if said predetermined time is reached, said step (a) is carried out; otherwise, said step (a) is not carried out.

6. The method of claim 4, wherein said predetermined time is predetermined by a time scheduling program.

7. A method for charging and maintaining a rechargeable battery, comprising:
(a) enabling a life extending mode;
(b) determining whether the unused period of said battery exceeds a predetermined time basis;
(c) discharging said battery;
(d) determining whether the electric potential of said battery is less than the low quantity level of said battery; and
(e) charging said battery.

8. The method of claim 7, wherein said battery is used in a laptop.

9. The method of claim 7, wherein said battery is a Ni-MH battery or a Ni—Cd battery.

10. The method of claim 7, further comprising a step of determining whether a predetermined time is reached or a predetermined hot key is started before said step (b).

11. The method of claim 10, wherein if said predetermined time is reached or said predetermined hot key is started, said step (c) and said step (d) are carried out; otherwise, said step (b) is carried out.

12. The method of claim 10, wherein said predetermined time is predetermined by a time scheduling program.

13. A method for charging and maintaining a rechargeable battery, comprising:
(a) enabling a life extending mode;
(b) determining whether the electric potential of said battery is less than or equal to a predetermined charging level;
(c) determining whether the unused period of said battery exceeds a predetermined time basis;
(d) discharging said battery;
(e) determining whether said battery is connected to a power supply; and
(f) charging said battery.

14. The method of claim 13, wherein said battery is used in a laptop.

15. The method of claim 13, wherein said battery is a Ni-MH battery or a Ni—Cd battery.

16. The method of claim 13, further comprising a step of determining whether a predetermined time is reached before said step (a).

17. The method of claim 16, wherein if said predetermined time is reached, said step (a) is carried out; otherwise, said step (a) is not carried out.

18. The method of claim 16, wherein said predetermined time is predetermined by a time scheduling program.

19. The method of claim 13, further comprising a step of determining whether a predetermined time is reached or a predetermined hot key is started before said step (b).

20. The method of claim 19, wherein if said predetermined time is reached or said predetermined hot key is started, said step (d) is carried out; otherwise, said step (b) is carried out.

21. The method of claim 19, wherein said predetermined time is predetermined by a time scheduling program.
